(19) United States
(12) Patent Application Publication
(10) Pub. No.: US 2026/0202368 A1
(43) Pub. Date: Jul. 16, 2026

(54) DETERMINATION DEVICE, ELECTROCHEMICAL DEVICE, AND DETERIORATION DETECTION METHOD

(71) Applicant: HONDA MOTOR CO., LTD., TOKYO (JP)

(72) Inventor: Tomohiro TAKAYANAGI, WAKO-SHI (JP)

(21) Appl. No.: 19/447,542

(22) Filed: Jan. 13, 2026

(30) Foreign Application Priority Data
Jan. 16, 2025 (JP) 2025-006148

(51) Int. Cl. G01N 27/04

(52) U.S. Cl. CPC G01N 27/041

(57) ABSTRACT

A determination device determines deterioration of an electrolyte membrane in an electrochemical device including an electrochemical cell and a volume portion in which gas generated by the electrochemical cell collects. The determination device includes a deterioration determination unit that determines whether or not the electrolyte membrane has deteriorated based on a detection signal of a detection sensor for detecting a current flowing between a first electrode and a second electrode, an output signal of a pressure sensor for detecting a pressure in the volume portion, a gas generation amount calculated from the current, and the pressure in the volume portion.

### CROSS-REFERENCE TO RELATED APPLICATIONS

This application is based upon and claims the benefit of priority from Japanese Patent Application No. 2025-006148 filed on Jan. 16, 2025, the contents of which are incorporated herein by reference.

### BACKGROUND OF THE INVENTION

### Field of the Invention

The present disclosure relates to a determination device that determines deterioration of an electrolyte membrane. The present disclosure also relates to an electrochemical device and a deterioration detection method.

### Description of the Related Art

An electrochemical cell in which an electrolyte membrane is disposed between an anode and a cathode is used in, for example, an electrochemical gas pump that compresses a gas such as hydrogen, a water electrolysis device, and the like. When the electrochemical device such as the electrochemical gas pump, the water electrolysis device, and the like is operated for a long period of time, the electrolyte membrane may become so thin that an amount of the generated gas that flows back (cross-leak amount) from the higher pressure side to the lower pressure side increases. Deterioration of the electrolyte membrane is also observed as a decrease in the amount of substance permeation (permeability), which occurs due to the current of the electrochemical cell. Degradation of permeability causes reduction of the ratio of the amount of substance permeation to the amount of cross leakage that normally occurs, resulting in a decrease in current efficiency apparently similar to an increase in the amount of cross leakage caused when the electrolyte membrane becomes thin. Therefore, in order to enable replacement of the electrochemical cell at an appropriate time, it is required to detect deterioration of the electrolyte membrane.

As a method for detecting deterioration of an electrolyte membrane in an electrochemical cell, there are known a method in which a gas sensor is provided in a gas flow path to detect leaked impurities, and a method in which a potential difference between an anode and a cathode reflecting cross leakage is measured (JP 2018-095953 A).

### SUMMARY OF THE INVENTION

The method using a gas sensor has a problem that cross leakage cannot be detected in the case where the electrochemical device is, for example, an electrochemical gas pump in which the same type of gas flows at both electrodes.

In addition, the method described in JP 2018-095953 A has a problem that deterioration of the electrochemical cell cannot be detected from data acquired during normal operation, and the replacement time cannot be predicted according to the progress of deterioration.

The present disclosure has the object of solving the aforementioned problem.

A first aspect of the present disclosure is characterized by a determination device configured to determine deterioration of an electrolyte membrane in an electrochemical device, the electrochemical device including: an electrochemical cell including the electrolyte membrane, a first electrode disposed on a first surface of the electrolyte membrane, and a second electrode disposed on a second surface of the electrolyte membrane opposite to the first surface; and a volume portion in which gas generated by the electrochemical cell collects, the determination device comprising: a current acquisition unit that acquires current information regarding the electrolyte membrane from a detection signal detected by a detection sensor that detects a current flowing between the first electrode and the second electrode; a pressure acquisition unit that acquires an output signal of a pressure sensor that detects a pressure in the volume portion; a deterioration determination unit that determines whether or not the electrolyte membrane has deteriorated based on the current information or a gas generation amount calculated from the current information, and the pressure in the volume portion, and a notification unit that notifies a result determined by the deterioration determination unit in a case where it is determined that the electrolyte membrane has deteriorated.

A second aspect of the present disclosure is an electrochemical device comprising: an electrochemical cell including an electrolyte membrane, a first electrode disposed on a first surface of the electrolyte membrane, and a second electrode disposed on a second surface of the electrolyte membrane opposite to the first surface; a volume portion in which gas generated by the electrochemical cell collects; a detection sensor configured to detect a current flowing between the first electrode and the second electrode; a pressure sensor configured to detect a pressure in the volume portion, a current acquisition unit that acquires current information regarding the electrolyte membrane from a detection signal of the detection sensor; and a deterioration determination unit that determines whether or not the electrolyte membrane has deteriorated based on the current information or a gas generation amount calculated from the current information, and the pressure in the volume portion.

A third aspect of the present disclosure is a method for detecting deterioration of an electrolyte membrane of an electrochemical device including an electrochemical cell having the electrolyte membrane, a first electrode disposed on a first surface of the electrolyte membrane, and a second electrode disposed on a second surface of the electrolyte membrane opposite to the first surface, and a volume portion in which gas generated in the electrochemical cell collects, the method comprising: a step of acquiring current information regarding the electrolyte membrane; a step of acquiring a pressure in the volume portion; and a step of determining whether or not the electrolyte membrane has deteriorated based on the current information or a gas generation amount calculated from the current information, and the pressure in the volume portion.

The present disclosure enables detection of deterioration of an electrolyte membrane based on current information and a gas pressure acquired during normal operation of an electrochemical device.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of an electrochemical device according to a first embodiment;

FIG. 2 is an illustration of an electrochemical cell of the electrochemical device of FIG. 1;

FIG. 3 is a flowchart illustrating a method of determining deterioration of an electrolyte membrane performed by a determination device shown in FIG. 1;

FIG. 4 is a graph showing an example of a change in a measured pressure detected by a pressure sensor and a change in a pressure calculated from a gas generation amount;

FIG. 5 is a flowchart illustrating a method for determining deterioration of an electrolyte membrane according to a first modification;

FIG. 6 is a graph showing an example of a gas generation rate calculated from a quantity of electricity and a gas generation rate calculated from a measured pressure;

FIG. 7 is a flowchart illustrating a method for determining deterioration of an electrolyte membrane according to a second modification;

FIG. 8 is a schematic configuration diagram of an electrochemical module according to a third modification;

FIG. 9 is a flowchart (fourth modification) illustrating a method for determining deterioration of an electrolyte membrane using the electrochemical module shown in FIG. 8; and

FIG. 10 is an illustration of an electrochemical cell according to another embodiment.

### DETAILED DESCRIPTION OF THE INVENTION

### First Embodiment

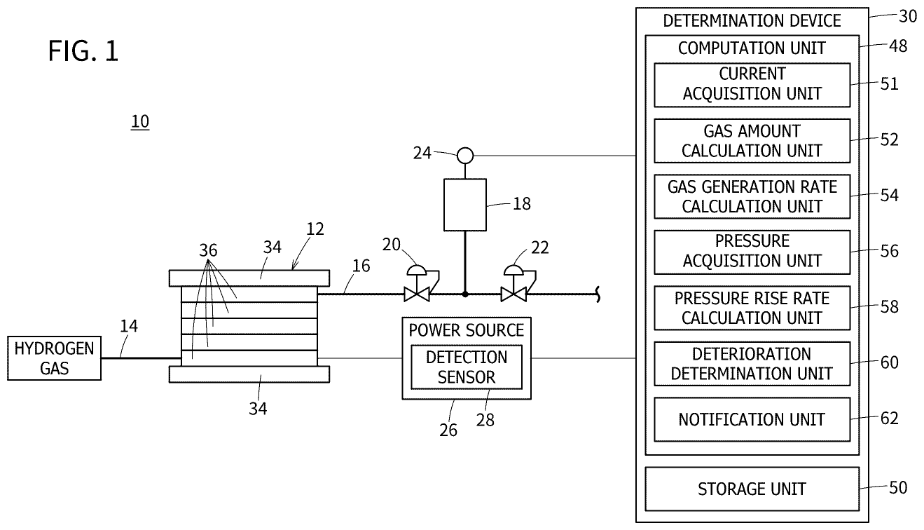

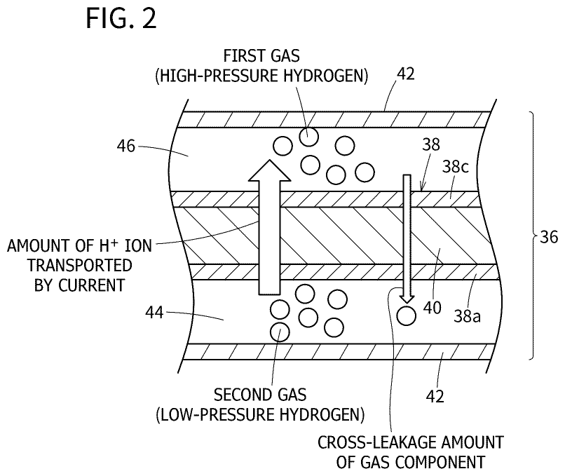

An electrochemical device 10 according to the present embodiment shown in FIGS. 1 and 2 is, for example, an electrochemical hydrogen pump that compresses a low-pressure hydrogen gas supplied from an anode 38a and outputs a high-pressure hydrogen gas from a cathode 38c. The electrochemical device 10 includes an electrochemical module 12, an introduction flow path 14, a discharge flow path 16, a tank 18, a first valve 20, a second valve 22, a pressure sensor 24, a power source 26, a detection sensor 28, and a determination device 30.

The electrochemical module 12 includes a plurality of electrochemical cells 36 between a pair of end plates 34. The plurality of electrochemical cells 36 are arranged in a stacked manner in the thickness direction.

The electrochemical cell 36 includes a pair of separator plates 42 and a membrane electrode assembly (MEA) 38 disposed between the separator plates 42. The separator plates 42 are formed of, for example, corrugated metal plates, and abut against the MEA 38 at predetermined positions to support the MEA 38.

An anode flow path 44 is formed between the anode separator plate 42 and the MEA 38, and a cathode flow path 46 is formed between the cathode separator plate 42 and the MEA 38. The anode flow paths 44 of the plurality of electrochemical cells 36 merge inside the electrochemical module 12 and communicate with the introduction flow path 14. The cathode flow paths 46 of the plurality of electrochemical cells 36 merge inside the electrochemical module 12, and communicate with the discharge flow path 16.

The MEA 38 includes an electrolyte membrane 40, the anode 38a, and the cathode 38c. In the present embodiment, the electrolyte membrane 40 is a proton-conductive electrolyte membrane. Examples of the material of the electrolyte membrane 40 include Nafion™ and the like.

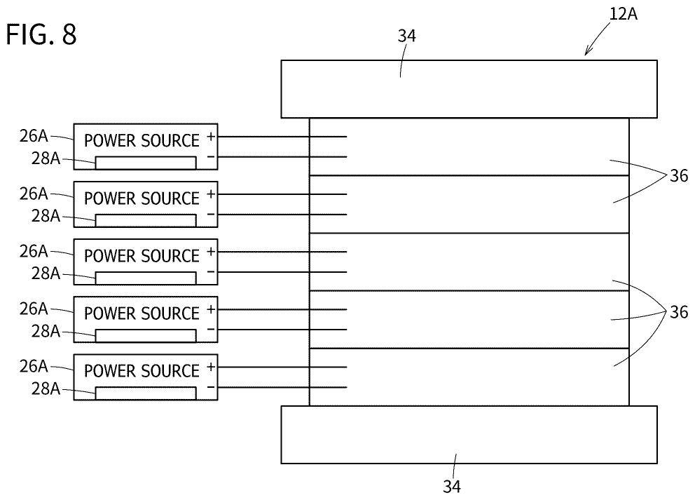

The anode 38a is formed on one surface (first surface) of the electrolyte membrane 40, and the cathode 38c is formed on the other surface (second surface) of the electrolyte membrane 40. The anode 38a is electrically connected to one of the separator plates 42, and the cathode 38c is electrically connected to the other of the separator plates 42, so that an electrical current is supplied to the electrochemical cell 36 via the separator plates 42. The plurality of electrochemical cells 36 are connected in series through the separator plates 42. The electrochemical cell 36 of the present embodiment is not limited to this structure, and the MEA 38 may be electrically insulated from the separator plates 42. In this case, as shown in FIG. 8, each of the MEAs 38 may be individually connected to power sources 26A.

When electrical power is supplied to the electrochemical device 10, an electrical current flows between the anode 38a and the cathode 38c of the MEA 38. In the electrolyte membrane 40, protons (H⁺ ions) are responsible for movement of electrical charges, and the protons in an amount corresponding to the quantity of electricity (C) are transported from the anode 38a to the cathode 38c. The transported protons are converted into hydrogen gas by an oxidation reaction at the cathode 38c. Since the transport of protons proceeds against the pressure difference between the cathode flow path 46 and the anode flow path 44, hydrogen output to the cathode flow path 46 is pressurized. A certain amount of the hydrogen gas in the cathode flow path 46 cross-leaks to the anode flow path 44 by diffusion through the electrolyte membrane 40.

The thickness of the electrolyte membrane 40 may decrease due to usage of the electrochemical device 10 for a long period of time. In this case, the cross-leak amount increases. The net amount of hydrogen gas generated decreases. The net amount of hydrogen gas generated is obtained by subtracting the cross-leak amount from the amount of hydrogen transported to the cathode flow path 46 per unit time with respect to the applied current. Therefore, in the electrochemical device 10, electrical current utilization efficiency is reduced. In addition, the permeability of the electrolyte membrane 40 may be degraded due to usage for a long period of time. In this case, the amount of hydrogen transported to the cathode flow path 46 per unit time decreases. In such a case as well, the net amount of hydrogen generated, which is obtained by subtracting the cross-leak amount from the amount of hydrogen output to the cathode flow path 46 per unit time decreases, and the electrical current utilization efficiency of the electrochemical device 10 decreases. In the present embodiment, deterioration refers to a state of the electrolyte membrane 40 in which the electrical current utilization efficiency is reduced by a predetermined value or more. A method of detecting a deteriorated electrolyte membrane 40 will be described later.

The introduction flow path 14 is connected to anode flow paths 44 inside the electrochemical module 12. The introduction flow paths 14 are supplied with low-pressure hydrogen gas.

The discharge flow path 16 is connected to the cathode flow paths 46 through an exhaust manifold provided in the end plate 34 of the electrochemical module 12. The discharge flow path 16 allows the hydrogen gas to be discharged from the electrochemical module 12. A tank 18 is connected to the discharge flow path 16 through the first valve 20. The first valve 20 is, for example, a back pressure valve, and opens when the pressure on the electrochemical module 12 side increases to a predetermined value or more, and guides the hydrogen gas to the tank 18.

The second valve 22 is connected to the discharge flow path 16 on the downstream side of the tank 18. The second valve 22 placed in a closed state prevents the hydrogen output from the electrochemical module 12 from flowing out and keeps the hydrogen stored in the tank 18. The second valve 22 is opened in accordance with the demand for the high-pressure hydrogen gas. When the second valve 22 is opened, the hydrogen gas is discharged from the tank 18 through the discharge flow path 16.

In the present embodiment, the cathode flow path 46, the tank 18, and the discharge flow path 16 in a range up to the second valve 22 are referred to as a volume portion. The volume of the volume portion is a value obtained by adding the volumes of the cathode flow path 46, the tank 18, and the discharge flow path 16 in the range up to the second valve 22.

The gas tank 18 is provided with the pressure sensor 24. The pressure sensor 24 detects the pressure of the hydrogen gas inside the tank 18.

The power source 26 provides electrical power to each of the electrochemical cells 36 of the electrochemical module 12. The power source 26 includes a detection sensor 28. The detection sensor 28 detects the current flowing between the anode 38a and the cathode 38c of each of the electrochemical cells 36.

The determination device 30 includes a computation unit (processing unit) 48 and a storage unit 50. The computation unit 48 may be constituted by a processor such as a Central Processing Unit (CPU) and a Graphics Processing Unit (GPU), and more specifically, processing circuitry.

The calculation unit 48 includes a current acquisition unit 51, a gas amount calculation unit 52, a gas generation rate calculation unit 54, a pressure acquisition unit 56, a pressure rise rate calculation unit 58, a deterioration determination unit 60, and a notification unit 62. The current acquisition unit 51, the gas amount calculation unit 52, the gas generation rate calculation unit 54, the pressure acquisition unit 56, the pressure rise rate calculation unit 58, the deterioration determination unit 60, and the notification unit 62 can be realized by the computation unit 48 executing programs stored in the storage unit 50.

At least a part of the current acquisition unit 51, the gas amount calculation unit 52, the gas generation rate calculation unit 54, the pressure acquisition unit 56, the pressure rise rate calculation unit 58, the deterioration determination unit 60, and the notification unit 62 may be realized by an integrated circuit such as an application specific integrated circuit (ASIC) or a field-programmable gate array (FPGA). At least a portion of the current acquisition unit 51, the gas amount calculation unit 52, the gas generation rate calculation unit 54, the pressure acquisition unit 56, the pressure rise rate calculation unit 58, the deterioration determination unit 60, and the notification unit 62 may be constituted by an electronic circuit including a discrete device.

The storage unit 50 may be constituted by a volatile memory and a non-volatile memory. Examples of the volatile memory include, for example, a RAM (Random Access Memory) or the like. The volatile memory is used as a working memory of the processor, and temporarily stores data or the like required for processing or calculations. As an example of the nonvolatile memory, there may be cited a ROM (Read Only Memory), a flash memory, or the like. The non-volatile memory is used as a storage memory, and serves to store a program, a table, a map, and the like. At least part of the storage unit 50 may be provided in the processor, the integrated circuit, and the like, as described above.

From a detection signal of the detection sensor 28, the current acquisition unit 51 acquires current information regarding the current flowing through the electrolyte membrane 40, that is, the current flowing between the electrodes of the electrochemical cell 36. The current acquisition unit 51 calculates an integrated current value of the current having flowed through the electrolyte membrane 40 by determining a time integrated value of the current information. The current acquisition unit 51 obtains the sum of the integrated current values of the plurality of electrochemical cells 36 as the quantity of electricity (C). The quantity of electricity acquired by the current acquisition unit 51 is used for calculating the gas generation amount.

The gas amount calculation unit 52 calculates the gas generation amount from the detection signal detected by the detection sensor 28. The gas amount calculation unit 52 calculates the gas generation amount (mol) based on the quantity of electricity acquired by the current acquisition unit 51 and the Faraday's law.

The gas generation rate calculation unit 54 calculates a gas generation rate (mol/hr), which is the amount of the gas generated by the electrochemical module 12 per unit time (hr) (increase rate), based on the change in the gas generation amount over time (gas generation amount obtained at a plurality of times) calculated by the gas amount calculation unit 52. The unit time can be appropriately determined from seconds(s), minutes (min), hours (hr), or the like according to the scale of the electrochemical device 10, the measurement conditions, or the like.

The pressure acquisition unit 56 acquires a pressure (Pa) in the tank 18 based on an output signal of the pressure sensor 24. In a state in which the first valve 20 is open, the pressure in the tank 18 is the same as the pressure in the volume portion, and therefore the pressure acquired by the pressure acquisition unit 56 can be regarded as the same as the pressure in the volume portion.

The pressure rise rate calculation unit 58 calculates a pressure rise rate (Pa/hr) which is a speed of increase in the pressure in the volume portion per unit time based on the change in the pressure acquired by the pressure acquisition unit 56 over time. The unit time here is the same as the unit time in the calculation of the gas generation rate.

The deterioration determination unit 60 detects deterioration of the electrolyte membrane 40 based on the gas generation rate and the pressure rise rate. The deterioration determination unit 60 calculates a theoretical pressure increase rate (Pa/hr) from the gas generation rate (mol/hr) based on the volume (L) of the volume portion, the temperature (K), and the gas state equation. The deterioration determination unit 60 determines that the electrolyte membrane 40 has deteriorated when the difference between the theoretical pressure increase rate and the pressure rise rate (measurement value) calculated by the pressure rise rate calculation unit 58 is equal to or greater than a predetermined value.

The notification unit 62 notifies a user, various devices, or the like of the determination result of the deterioration determination unit 60.

The electrochemical device 10 according to the present embodiment is configured in the manner described above. Hereinafter, a description will be given concerning the operations of the electrochemical device 10.

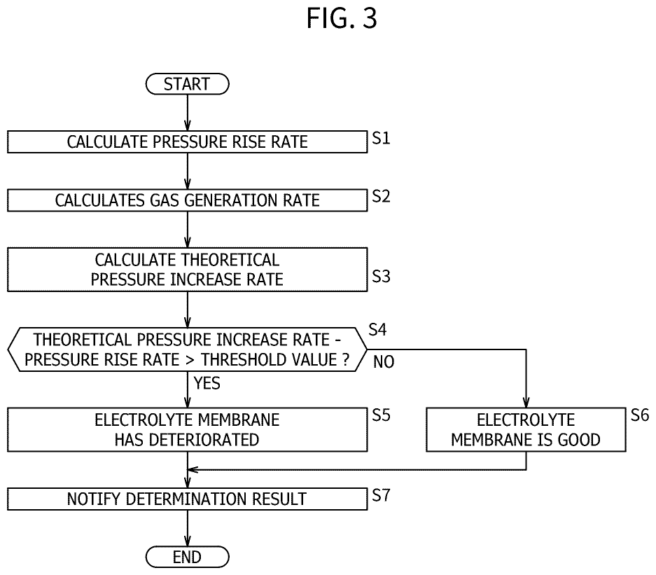

As shown in FIG. 3, in the electrochemical device 10, the power source 26 supplies electrical power to the electrochemical module 12 in a normal compression operation. Hydrogen gas introduced through the introduction flow path 14 is output to the discharge flow path 16 by the electrochemical module 12 supplied with the electrical power. While the second valve 22 is kept closed, hydrogen gas is gradually accumulated in the volume portion including the tank 18, and thus the pressure in the volume portion increases.

The determination device 30 performs the deterioration determination of the electrolyte membrane 40 shown in FIG. 3 at an appropriate timing during the compression operation of the electrochemical device 10.

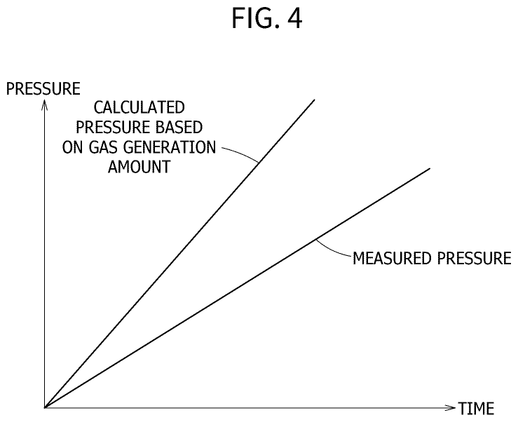

The deterioration determination of the electrolyte membrane 40 starts at step S1 in FIG. 3. In step S1, the determination device 30 calculates the pressure rise rate at the volume portion. The pressure rise rate calculation unit 58 calculates an approximation function (linear approximation) of the pressure with respect to time based on recorded data of the pressure acquired by the pressure acquisition unit 56 and the time (for example, FIG. 4). The pressure rise rate calculation unit 58 calculates the pressure rise rate from the slope of the approximation function (FIG. 4).

Next, in step S2, the determination device 30 calculates the gas generation rate. The storage unit 50 stores data of the gas generation amount calculated based on the quantity of electricity acquired by the current acquisition unit 51 and associated with time by the gas amount calculation unit 52. The gas generation rate calculation unit 54 reads out the recorded data of the gas generation amount and the time are from the storage unit 50, calculates the approximation function (linear approximation) of the gas generation amount with respect to the time, and calculates the gas generation rate from the slope of the approximation function.

Next, in step S3, the determination device 30 calculates the theoretical pressure increase rate by the deterioration determination unit 60. The deterioration determination unit 60 substitutes the values of the gas generation rate n (mol/hr) calculated in step S2, the volume V (L) of the volume portion, and the temperature T (K) into the state equation of hydrogen gas to obtain a theoretical pressure increase rate, which is a theoretical pressure increase rate obtained from the current. As the state equation, for example, an ideal gas state equation, a van der Waals state equation, a virial equation, or the like can be used. For example, in the case of the ideal gas state equation, the theoretical pressure increase rate is calculated by nRT/V (where R is the gas constant).

The deterioration determination unit 60 may calculate the pressure at each time from the recorded data of the gas generation amount and the time, as shown in FIG. 4. In this case, the theoretical pressure increase rate is obtained from the slope of the approximation function (linear approximation) of the calculated pressure and the time.

Next, in step S4, the determination device 30 determines by the deterioration determination unit 60 whether or not the difference between the theoretical pressure increase rate obtained in step S3 and the pressure rise rate acquired in step S1 exceeds a predetermined threshold. If it is determined that the difference exceeds the predetermined threshold (YES), the process proceeds to step S5 where the deterioration determination unit 60 determines that the electrolyte membrane 40 has deteriorated. Thereafter, in step S7, the notification unit 62 notifies the user that the electrolyte membrane 40 has deteriorated.

If it is determined in step S4 that the difference between the theoretical pressure increase rate and the pressure rise rate (actual measurement) is equal to or less than the predetermined threshold (NO), the process proceeds to step S6 where it is determined that the electrolyte membrane 40 is good. Thereafter, in step S7, the notification unit 62 notifies the user that the electrolyte membrane 40 is good. In step S7, the notification unit 62 may notify the user or the like of the difference value between the theoretical pressure increase rate and the pressure rise rate (actual measurement), the current efficiencies, or the like, together with the determination result.

As described above, the electrochemical device 10 can detect the deterioration of the electrolyte membrane 40. In the present embodiment, the influence of measurement errors can be suppressed by using the pressure rise rate and the gas generation rate. This makes it possible to grasp the deterioration of the electrolyte membrane 40 by using the data that can be acquired during normal operation of the electrochemical device 10.

In the electrochemical device 10 of the present embodiment, the determination device 30 can also acquire a change in the difference between the theoretical pressure increase rate and the pressure rise rate (actual measurement) over time and predict the operation time until the predetermined threshold is reached. In this case, the maintenance time of the electrochemical module 12 can be predicted in advance, and the electrochemical device 10 can be operated as planned over a long period of time.

Although the hydrogen at a low pressure is supplied to the anode 38a of the electrochemical cell 36 of the electrochemical device 10 described above, the present embodiment is not limited thereto. The electrochemical cell 36 can be configured as a proton exchange membrane (PEM) water electrolysis cell. In this case, the anode 38a is configured to be supplied with water and the water is electrolyzed, so that an oxygen gas is generated at the anode 38a and a hydrogen gas is generated at the cathode 38c. The tank 18 is connected to the cathode flow path 46 through the discharge flow path 16, whereby a high-pressure hydrogen gas is obtained. Even in such an electrochemical cell 36, the determination device 30 can detect deterioration of the electrolyte membrane 40 based on the relationship between the current information and the pressure of the high-pressure hydrogen gas.

Hereinafter, various modifications of the electrochemical device 10 of the present embodiment will be described.

### First Modification

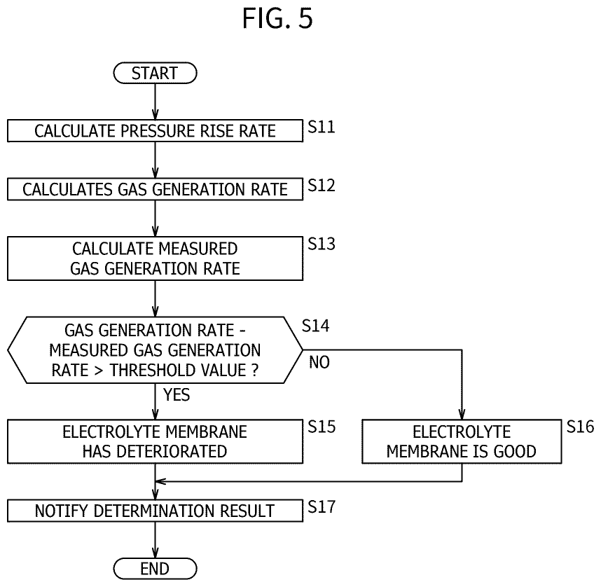

As shown in FIG. 5, the present modification relates to another example of the method of determining deterioration of the electrolyte membrane 40 performed by the determination device 30.

In the present modification, first, in step S11, the pressure rise rate calculation unit 58 calculates the pressure rise rate. Step S11 is the same as step S1 in FIG. 3.

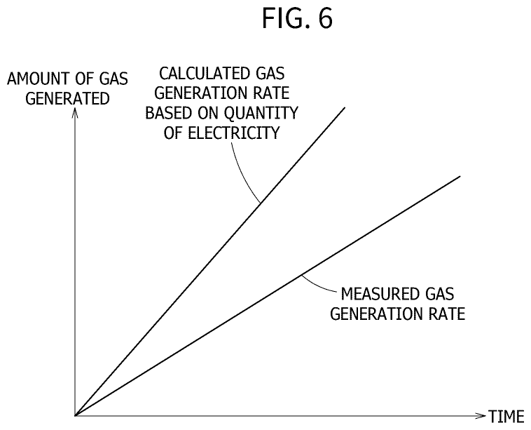

Next, in step S12 of FIG. 5, the gas generation rate calculation unit 54 calculates the gas generation rate. Step S12 is the same as step S2 in FIG. 3. As shown in FIG. 6, the gas generation rate is determined from the slope of the approximate function of time and gas generation amount.

Next, in step S13, the determination device 30 calculates the measured gas generation rate per unit time (mol/hr) based on the pressure rise rate acquired in step S11. The measured gas generation rate is calculated by substituting the pressure rise rate dP/dt, the volume of the volume portion V, and the temperature T into the state equation of hydrogen gas. For example, when the ideal gas state equation is used with R as the gas constant, the measured gas generation rate is obtained as (dP/dt)×V/RT.

Since the cross leakage occurs even if the electrolyte membrane 40 is good, the measured gas generation rate is smaller than the gas generation rate calculated from the quantity of electricity as shown in FIG. 6.

Next, in step S14, the deterioration determination unit 60 of the determination device 30 determines whether or not the difference between the calculated gas generation rate and the measured gas generation rate exceeds a predetermined threshold. In step S14, when the deterioration determination unit 60 determines that the difference exceeds the predetermined threshold (YES), the process proceeds to step S15. In step S15, the deterioration determination unit 60 determines that the electrolyte membrane 40 has deteriorated, and then, in step S17, the notification unit 62 notifies the user or the like that the electrolyte membrane 40 has deteriorated.

On the other hand, if the deterioration determination unit 60 determines that the difference does not exceed the predetermined threshold (NO) in step S14, the process proceeds to step S16. In step S16, the deterioration determination unit 60 determines that the electrolyte membrane 40 is good, and then, in step S17, the notification unit 62 notifies the user that the electrolyte membrane 40 is good.

As described above, in the present modification, the deterioration of the electrolyte membrane 40 is detected by calculating the measured gas generation rate instead of the theoretical pressure increase rate.

### Second Modification

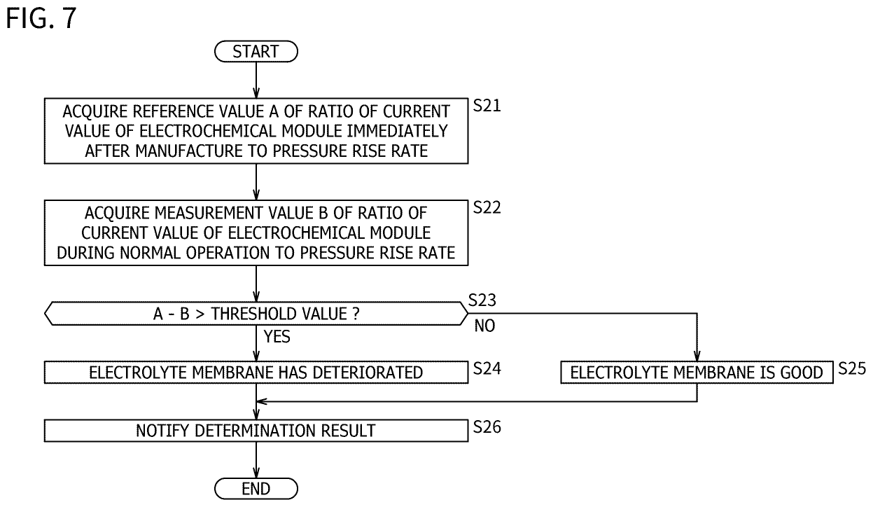

As shown in FIG. 7, the present modification relates to still another example of the method of determining deterioration of the electrolyte membrane 40 performed by the determination device 30.

In the present modification, first, in step S21, the determination device 30 acquires the ratio of a current value I of the current supplied to the electrochemical module 12 immediately after manufacture to a pressure rise rate dP/dt as a reference value A (=dP/dt)/I. The value of the current supplied to the electrochemical module 12 is obtained as the sum of the currents flowing through the electrochemical cells 36. In the case where the electrochemical cells 36 are connected in series, the current value I of the current supplied to the electrochemical module 12 is obtained by multiplying the current based on the detection signal of the detection sensor 28 by the number of the electrochemical cells 36. The current value I used for calculation of the reference value A is assumed to be maintained constantly. The pressure rise rate dP/dt is an actual measurement value obtained based on the detection signal of the pressure sensor 24.

Next, in step S22, the determination device 30 acquires the ratio of a current value I of the current supplied to the electrochemical module 12 during normal operation to the pressure rise rate dP/dt, as a measurement value B (=(dP/dt)/I). The measurement value B in step S22 differs from the reference value A in step S21 in that the measurement value B is obtained from the electrochemical module 12 not immediately after manufacture, but after some time has elapsed since the operation started. The method of acquiring the current value I and the voltage increase rate dP/dt in step S22 is the same as that in step S21. In the case where the cross-leak amount increases due to deterioration of the electrolyte membrane 40, the pressure rise rate dP/dt decreases, and thus the measurement value B decreases in accordance with deterioration of the electrolyte membrane 40.

Next, in step S23, the deterioration determination unit 60 determines whether or not the difference between the reference value A and the measurement value B exceeds a predetermined value. If it is determined in step S23 that the difference between the reference value A and the measurement value B exceeds the predetermined value (YES), the process proceeds to step S24, and the deterioration determination unit 60 determines that the electrolyte membrane 40 has deteriorated. Thereafter, in step S26, the notification unit 62 notifies the user that the electrolyte membrane 40 has deteriorated.

If it is determined in step S23 that the difference between the reference value A and the measurement value B does not exceed the predetermined value (NO), the process proceeds to step S25 and the deterioration determination unit 60 determines that the electrolyte membrane 40 is good. Thereafter, in step S26, the notification unit 62 notifies the user that the electrolyte membrane 40 is good.

As described above, in the present modification, the deterioration of the electrolyte membrane 40 can be detected based on the current value I and the pressure rise rate dP/dt without using the volume V of the volume portion. By acquiring the time transition of the measurement value B, the deterioration of the electrolyte membrane 40 can be predicted, and the maintenance time of the electrochemical module 12 can be predicted, which is preferable.

### Third Modification

As shown in FIG. 8, in this modification, an electrochemical module 12A and power sources 26A according to another configuration example will be described. By replacing the electrochemical module 12, the power source 26, and the detection sensor 28 of the electrochemical device 10 in FIG. 1 with the electrochemical module 12A, the power sources 26A, and detection sensors 28A, other components can be used in the present modification.

As shown in FIG. 8, the electrochemical module 12A includes a plurality of electrochemical cells 36 arranged between a pair of end plates 34. The plurality of electrochemical cells 36 are stacked in the thickness direction. In the electrochemical module 12A, the electrochemical cells 36 adjacent to each other in the thickness direction are electrically insulated from each other.

The number of the power sources 26A is the same as the number of the electrochemical cells 36. One power source 26A supplies current to one electrochemical cell 36. Each power source 26A is provided with a detection sensor 28A. The detection sensor 28A detects the current flowing through the electrochemical cell 36.

In this modification, the quantity of electricity (C) can be obtained by summing the integrated values of the currents flowing through the individual electrochemical cells 36. In this way, by acquiring the currents flowing through the individual electrochemical cells 36, the amount of hydrogen gas generated (mol) can be calculated more accurately. That is, variations may occur depending on the position of each electrochemical cell 36, due to drying or excessive moisture of the anode 38a, the cathode 38c, and the electrolyte membrane 40, and the current flowing through each electrochemical cell 36 may differ. In such a case, if the value of the current supplied to the entire electrochemical module 12A is used, the current flowing through each electrochemical cell 36 is not accurately reflected in the current information. The influence of moisture is excluded by using detection results of the current values of the individual electrochemical cells 36 as in the present modification.

In the electrochemical module 12A of the present modification, deterioration of the electrolyte membrane 40 can be detected by the method described with reference to FIGS. 3, 5, or 7.

### Fourth Modification

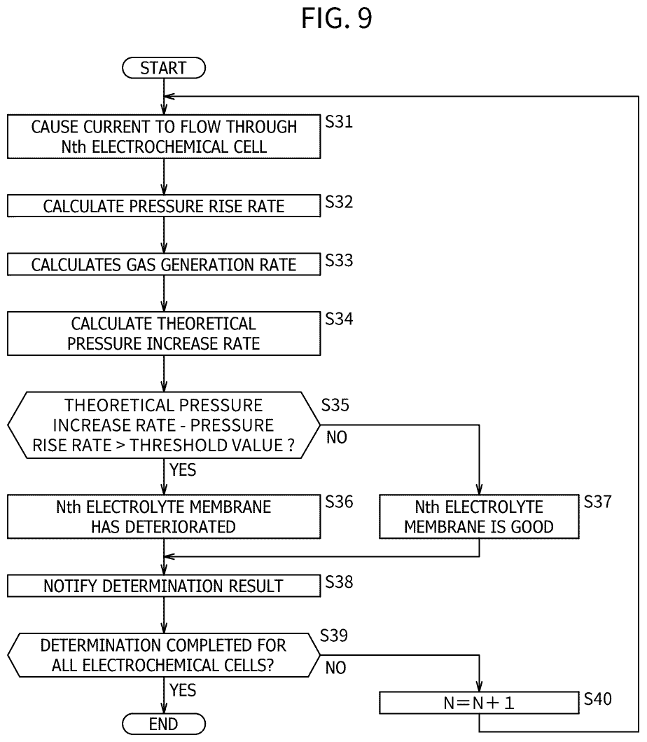

The present modification shown in FIG. 9 is a method for detecting deterioration of individual electrolyte membranes 40 using the electrochemical module 12A of FIG. 8. In the conventional method, in an electrochemical module 12 having a plurality of electrochemical cells 36, it is not possible to determine which of electrolyte membranes 40 of the electrochemical cells 36 has deteriorated. As the deterioration determination method of the present modification, an explanation will be given regarding a method that enables determination of which electrolyte membrane 40 has deteriorated. The following description is based on a device configuration in which the electrochemical module 12 and the power source 26 of the electrochemical device 10 in FIG. 1 are replaced with the electrochemical module 12A and the power sources 26A in FIG. 8.

First, as shown in step S31, the determination device 30 (see FIG. 1) causes a current to flow through the first one of the electrochemical cells 36 via the first one of the power sources 26A. In step S31, no current is supplied to the rest of the electrochemical cells 36.

Next, in step S32, the pressure rise rate calculation unit 58 (see FIG. 1) calculates the pressure rise rate of the volume portion. The pressure rise rate calculation unit 58 obtains the pressure rise rate of the volume portion by the same operation as that of step S1 in FIG. 3.

Next, in step S33, the gas generation rate calculation unit 54 (see FIG. 1) calculates the gas generation rate (mol/hr) of the hydrogen gas generated per unit time based on the quantity of electricity (C) flowing through the first one of the electrochemical cells 36 and the Faraday's law.

Next, in step S34, the pressure rise rate calculation unit 58 calculates a theoretical pressure increase rate (Pa/hr) from the gas generation rate obtained in step S33, the volume of the volume portion, the temperature, and the state equation of hydrogen gas.

Next, in step S35, the deterioration determination unit 60 determines whether or not the difference between the theoretical pressure increase rate and the pressure rise rate (actual measurement) exceeds a predetermined threshold. If it is determined in step S35 that the difference exceeds the predetermined threshold (YES), the process proceeds to step S36 where the deterioration determination unit 60 determines that the electrolyte membrane 40 of the first one of the electrochemical cells through which the current flows may have deteriorated. If the difference is equal to or less than the predetermined threshold (NO) in step S35, the process proceeds to step S37 where the deterioration determination unit 60 determines that the electrolyte membrane 40 of the first one of the electrochemical cells through which the current flows is good.

Thereafter, in step S38, the notification unit 62 notifies the user that the electrolyte membrane 40 has deteriorated.

Next, in step S39, the determination device 30 determines whether or not the deterioration determination of all the electrochemical cells 36 has been completed. When the deterioration determination of all the electrochemical cells 36 has not been completed (NO), the process proceeds to step S40 where the counter that designates the electrochemical cell 36 to be determined is incremented by one, and the process returns to step S31. Thereafter, the processes of steps S31 to S40 are repeated until the deterioration determination is completed for all the electrochemical cells 36. If the determination in step S39 is YES, the process comes to an end.

The deterioration determination of the present modification as described above enables detection of the electrolyte membrane 40 with degraded permeability.

### Other Embodiments

The above description has been made by taking, as an example, a case where the electrochemical cell 36 is an electrochemical hydrogen pump that electrochemically compress hydrogen gas, but the above disclosure is not limited thereto.

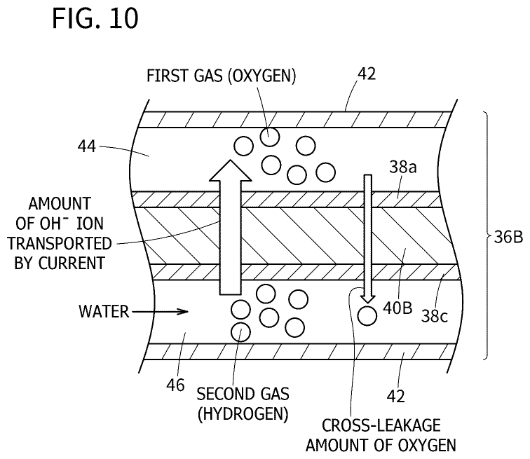

In the electrochemical device 10 of FIG. 1, the same effect can be obtained even if the electrochemical cell 36 is replaced with an electrochemical cell 36B shown in FIG. 10. The electrochemical cell 36B of FIG. 10 uses an anion conducting electrolyte membrane that conducts hydroxide ions as an electrolyte membrane 40B. In the electrochemical cell 36B, the cathode 38c is supplied with water or super-humidified hydrogen or the like. The water supplied to the cathode 38c is electrolyzed to generate hydrogen in the cathode 38c. Further, the oxygen is transported as hydroxide ions through the electrolyte membrane 40B, and generates oxygen-containing gas at the anode 38a. The tank 18 is connected to the anode flow path 44 through the discharge flow path 16. In the modification shown in FIG. 10, oxygen gas is the first gas, and the anode flow path 44, the discharge flow path 16, and the tank 18 constitute the volume portion. In this case, the deterioration of the electrolyte membrane 40B is detected based on the information of the current flowing through the electrochemical cell 36B and the pressure in the volume portion (the pressure of the oxygen-containing gas).

The following supplementary notes are further disclosed in relation to the above embodiment.

### Supplementary Note 1

The determination device (30) of the present disclosure is configured to determine deterioration of the electrolyte membrane (40) in the electrochemical device (10), the electrochemical device including: the electrochemical cell (36) including the electrolyte membrane, the first electrode disposed on the first surface of the electrolyte membrane, and the second electrode disposed on the second surface of the electrolyte membrane opposite to the first surface; and the volume portion in which gas generated by the electrochemical cell collects, the determination device comprising: the current acquisition unit (51) that acquires current information regarding the electrolyte membrane from a detection signal detected by the detection sensor (28) that detects a current flowing between the first electrode and the second electrode; the pressure acquisition unit (56) that acquires an output signal of a pressure sensor (24) that detects a pressure in the volume portion; the deterioration determination unit (60) that determines whether or not the electrolyte membrane is deteriorated based on the current information or a gas generation amount calculated from the current information, and the pressure in the volume portion, and the notification unit (62) that notifies a result determined by the deterioration determination unit in a case where it is determined that the electrolyte membrane has deteriorated.

The determination device can detect the deterioration of the electrolyte membrane using the current information and the pressure in the volume portion that are acquired during normal operation of the electrochemical device.

### Supplementary Note 2

The determination device according to Supplementary Note 1 may further include the gas amount calculation unit (52) configured to calculate the gas generation amount based on a quantity of electricity obtained from the current information. The determination device can accurately obtain the gas generation amount from the current information, and can detect the deterioration of the electrolyte membrane by comparing the gas generation amount with a physical quantity such as the pressure in the volume portion.

### Supplementary Note 3

The determination device according to Supplementary Note 2 may further include the gas generation rate calculation unit (54) configured to calculate a gas generation rate, which is a rate of increase of the gas generation amount, based on the gas generation amount obtained at a plurality of times, and the pressure rise rate calculation unit (58) configured to calculate a pressure rise rate (dp/dt), which is a rate of increase of the pressure, based on the pressure obtained at a plurality of times, wherein the deterioration determination unit may determine whether or not the electrolyte membrane is deteriorated based on the gas generation rate and the pressure rise rate. The determination device can accurately evaluate the characteristics of the electrolyte membrane by suppressing the influence of the offset and the variation of the gas generation amount and the pressure.

### Supplementary Note 4

In the determination device according to Supplementary Note 3, the deterioration determination unit may determine a theoretical pressure increase rate of the gas based on the gas generation rate and the volume of the volume portion, and may determine that the electrolyte membrane has deteriorated in a case where a difference between the theoretical pressure increase rate and the pressure rise rate that is calculated from the pressure detected by the pressure sensor is equal to or larger than a predetermined value. The determination device can detect the deterioration of the electrolyte membrane by comparing the pressure rise rate calculated from the current information with the pressure rise rate based on the actual measurement.

### Supplementary Note 5

In the determination device according to Supplementary Note 3, the deterioration determination unit may determine a measured gas generation rate of the gas based on the pressure rise rate and the volume of the volume portion, and may determine that the electrolyte membrane has deteriorated when a difference between the gas generation rate and the measured gas generation rate is equal to or greater than a predetermined value. The determination device converts the actually measured pressure rise rate into the gas generation amount, thereby enabling comparison with the gas generation amount obtained from the current information and enabling detection of deterioration of the electrolyte membrane.

### Supplementary Note 6

In the determination device according to Supplementary Note 2, the electrochemical cell includes a plurality of electrochemical cells, the current acquisition unit may acquire currents respectively flowing through the electrochemical cells, and the gas amount calculation unit may calculate the gas generation amount from a sum of the currents. This determination device can eliminate the influence of variation in the quantity of electricity due to drying or excessive humidity of each of the electrochemical cells, and can improve the accuracy of calculation of the gas generation amount based on the current information.

### Supplementary Note 7

The determination device according to Supplementary Note 1 may further include a pressure rise rate calculation unit that calculates a pressure rise rate, which is a rate of increase of the pressure, based on the pressure obtained at a plurality of times, and the deterioration determination unit may determine whether or not the electrolyte membrane has deteriorated based on a relationship between the current information and the pressure rise rate. The determination device can determine deterioration of the electrolyte membrane without obtaining the volume of the volume portion.

### Supplementary Note 8

The electrochemical device of the present disclosure comprises: the electrochemical cell including the electrolyte membrane, the first electrode disposed on the first surface of the electrolyte membrane, and the second electrode disposed on the second surface of the electrolyte membrane opposite to the first surface; the volume portion in which gas generated by the electrochemical cell collects; the detection sensor configured to detect a current flowing between the first electrode and the second electrode; the pressure sensor configured to detect a pressure in the volume portion, the current acquisition unit configured to acquire current information regarding the electrolyte membrane from a detection signal of the detection sensor; and the deterioration determination unit configured to determine whether or not the electrolyte membrane has deteriorated based on the current information or a gas generation amount calculated from the current information, and the pressure in the volume portion.

### Supplementary Note 9

In the electrochemical device according to Supplementary Note 8, the electrochemical cell may electrolyze water to generate hydrogen in the volume portion.

### Supplementary Note 10

In the electrochemical device according to Supplementary Note 9, the electrochemical cell may be an electrochemical hydrogen pump configured to compress a low-pressure hydrogen gas supplied to the second electrode and output a high-pressure hydrogen gas to the volume portion.

### Supplementary Note 11

In the electrochemical device according to Supplementary Note 10, the volume portion may include a discharge flow path (16) configured to communicate with the first electrode and allow the gas to be discharged from the electrochemical cell, and a tank (18) connected to the discharge flow path. In this electrochemical device, detection errors of the pressure rise rate can be suppressed by increasing the volume of the tank.

### Supplementary Note 12

The method of the present disclosure for detecting deterioration of the electrolyte membrane of the electrochemical device including the electrochemical cell having the electrolyte membrane, the first electrode disposed on the first surface of the electrolyte membrane, and the second electrode disposed on the second surface of the electrolyte membrane opposite to the first surface, and the volume portion in which gas generated in the electrochemical cell collects, comprises: the step of acquiring current information regarding the electrolyte membrane; the step of acquiring a pressure in the volume portion; and the step of determining whether or not the electrolyte membrane is deteriorated based on the current information or a gas generation amount calculated from the current information, and the pressure in the volume portion. This deterioration detection method can detect deterioration of the electrolyte membrane from the current information and the pressure acquired during normal operation of the electrochemical device.

Although concerning the present disclosure, a detailed description thereof has been presented above, the present disclosure is not necessarily limited to the individual embodiments described above. These embodiments may be subjected to various additions, substitutions, modifications, partial deletions, and the like, within a range that does not deviate from the essence and gist of the present disclosure, or the spirit of the present disclosure as derived from the contents described in the claims and equivalents thereof. Further, these embodiments can also be implemented in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A determination device configured to determine deterioration of an electrolyte membrane in an electrochemical device, the electrochemical device comprising: an electrochemical cell including the electrolyte membrane, a first electrode disposed on a first surface of the electrolyte membrane, and a second electrode disposed on a second surface of the electrolyte membrane opposite to the first surface; and a volume portion in which gas generated by the electrochemical cell collects,
the determination device comprising one or more processors that execute computer-executable instructions stored in a memory, wherein the one or more processors execute the computer-executable instructions to cause the determination device to:
acquire current information regarding the electrolyte membrane from a detection signal detected by a detection sensor configured to detect a current flowing between the first electrode and the second electrode;
acquire an output signal of a pressure sensor configured to detect a pressure in the volume portion;
determine whether or not the electrolyte membrane is deteriorated based on the current information or a gas generation amount calculated from the current information, and the pressure in the volume portion; and
notify a result of determination in a case where it is determined that the electrolyte membrane has deteriorated.

2. The determination device according to claim 1, wherein the one or more processors cause the determination device to:
calculate the gas generation amount based on a quantity of electricity obtained from the current information.

3. The determination device according to claim 2, wherein the one or more processors cause the determination device to:
calculate a gas generation rate, which is a rate of increase of the gas generation amount, based on the gas generation amount obtained at a plurality of times;
calculate a pressure rise rate, which is a rate of increase of the pressure, based on the pressure obtained at a plurality of times; and
determine whether or not the electrolyte membrane has deteriorated based on the gas generation rate and the pressure rise rate.

4. The control device according to claim 3, wherein the one or more processors cause the determination device to:
determine a theoretical pressure increase rate of the gas based on the gas generation rate and the volume of the volume portion; and
determine that the electrolyte membrane has deteriorated in a case where a difference between the theoretical pressure increase rate and the pressure rise rate that is calculated from the pressure detected by the pressure sensor is equal to or larger than a predetermined value.

5. The control device according to claim 3, wherein the one or more processors cause the determination device to:
determine a measured gas generation rate of the gas based on the pressure rise rate and the volume of the volume portion; and
determine that the electrolyte membrane has deteriorated when a difference between the gas generation rate and the measured gas generation rate is equal to or greater than a predetermined value.

6. The control device according to claim 2, wherein
the electrochemical cell includes a plurality of electrochemical cells, and
the one or more processors cause the determination device to:
acquire currents respectively flowing through the plurality of electrochemical cells; and
calculate the gas generation amount from a sum of the currents.

7. The control device according to claim 1, wherein the one or more processors cause the determination device to:
calculate a pressure rise rate, which is a rate of increase of the pressure, based on the pressure obtained at a plurality of times, and
determine whether or not the electrolyte membrane has deteriorated based on a relationship between the current information and the pressure rise rate.

8. An electrochemical device comprising:
an electrochemical cell including an electrolyte membrane, a first electrode disposed on a first surface of the electrolyte membrane, and a second electrode disposed on a second surface of the electrolyte membrane opposite to the first surface;
a volume portion in which gas generated by the electrochemical cell collects;
a detection sensor configured to detect a current flowing between the first electrode and the second electrode; and
a pressure sensor configured to detect a pressure in the volume portion;
one or more processors that execute computer-executable instructions stored in a memory, wherein
the one or more processors execute the computer-executable instructions to cause the electrochemical device to:
acquire current information regarding the electrolyte membrane from a detection signal of the detection sensor; and
determine whether or not the electrolyte membrane has deteriorated based on the current information or a gas generation amount calculated from the current information, and the pressure in the volume portion.

9. The electrochemical device according to claim 8, wherein the electrochemical cell electrolyzes water to generate hydrogen in the volume portion.

10. The electrochemical device according to claim 9, wherein the electrochemical cell is an electrochemical hydrogen pump configured to compress a low-pressure hydrogen gas supplied to the second electrode and output a high-pressure hydrogen gas to the volume portion.

11. The electrochemical device according to claim 10, wherein the volume portion includes:
a discharge flow path configured to communicate with the first electrode and allow the gas to be discharged from the electrochemical cell, and
a tank connected to the discharge flow path.

12. A method for detecting deterioration of an electrolyte membrane of an electrochemical device, the electrochemical device comprising: an electrochemical cell including the electrolyte membrane, a first electrode disposed on a first surface of the electrolyte membrane, and a second electrode disposed on a second surface of the electrolyte membrane opposite to the first surface; and a volume portion in which gas generated in the electrochemical cell collects,
the method comprising:
acquiring current information regarding the electrolyte membrane;
acquiring a pressure in the volume portion; and
determining whether or not the electrolyte membrane is deteriorated based on the current information or a gas generation amount calculated from the current information, and the pressure in the volume portion.
